(19) United States
(12) Patent Application Publication
(10) Pub. No.: US 2015/0205047 A1
(43) Pub. Date: Jul. 23, 2015

(54) POLARIZATION SEPARATOR, POLARIZATION SEPARATION STRUCTURE, OPTICAL MIXER, AND METHOD FOR MANUFACTURING POLARIZATION SEPARATOR

(71) Applicant: NEC Corporation, Tokyo (JP)

(72) Inventor: Hiroyuki Yamanashi, Yamanashi (JP)

(73) Assignee: NEC Corporation, Tokyo (JP)

(21) Appl. No.: 14/414,963

(22) PCT Filed: Mar. 27, 2013
(86) PCT No.: PCT/JP2013/002100

§ 371 Date: Jan. 15, 2015

(30) Foreign Application Priority Data
Jul. 17, 2012 (JP) 2012-158615

(51) Int. Cl. G02B 6/27; G02B 6/125; G02B 6/28; G02B 6/126

(52) U.S. Cl. CPC G02B 6/2773; G02B 6/126; G02B 6/125; G02B 6/2808; G02B 2006/1215

(57) ABSTRACT

A polarization separator includes a polarization separation film, an analyzer, and optical waveguides. The analyzer emits a linearly polarized light of a light, the linearly polarized light including a TE light and a TM light, the intensities of the TE TM lights being equal to each other. The polarization separation film is arranged on a substrate, transmits a TE light, reflects a TM light, and performing polarization separation on the linearly polarized light. An end surface of the first optical waveguide is opposed to a first surface of the polarization separation film, and a waveguide direction of the first optical waveguide is a direction in which the TE light propagates. An end surface of the second optical waveguide is opposed to a second surface of the polarization separation film, and a waveguide direction of the second optical waveguide is a direction in which the TM light propagates.

### TECHNICAL FIELD

The present invention relates to a polarization separator, a polarization separation structure, an optical mixer, and a method for manufacturing the polarization separator, and relates to, for example, a polarization separator, a polarization separation structure, an optical mixer, and a method for manufacturing the polarization separator applied to an optical communication system.

### BACKGROUND ART

With an increase in transmission rate of an optical communication system, investigations of the communication system that enables large-capacity and high-speed communication more efficiently have been carried out energetically. Among them, Dual-polarization Quadrature phase shift keying (DP-QPSK) is a modulation method which have received the most attention in the 100 Gigabit Ethernet (Ethernet: registered trademark) (100GE) transmission apparatus. In the DP-QPSK system, polarization multiplexing is carried out in addition to phase multi-level modulation, thereby increasing the transmission capacity. In order to carry out the polarization multiplexing or the polarization separation, polarization separators have been widely used. The polarization separator is formed of birefringence optical crystal or a special multi-layer film and is able to perform a low-loss operation at a high polarization extinguish ratio.

A configuration using the birefringence optical crystal requires a collimated optical system that uses two lenses, which makes it difficult to reduce the size. Meanwhile, the size of a polarization separation element formed by introducing a multi-layer film in a waveguide element can be reduced (e.g., Non-patent literature 1). FIG. 6 is a configuration diagram showing an arrangement of a polarization separation film and an optical waveguide when polarization separation is carried out by the polarization separation film arranged in the optical waveguide. An optical waveguide 701 is partly cut off at a position where a polarization separation film 702 is arranged. The polarization separation film 702 is arranged at the position where the optical waveguide 701 is cut off. The reflection characteristics and the transmission characteristics of the polarization separation film 702 vary depending on the polarization state of an incident light 704. Specifically, the polarization separation film 702 transmits a TE component 706 of the incident light 704 and reflects a TM component 705 of the incident light 704. As a result, the TE component 706 of the incident light 704 directly propagates through the optical waveguide 701. On the other hand, the TM component 705 of the incident light 704 is reflected and propagates through an optical waveguide 703. Accordingly, the optical waveguide 701 is polarized and separated into the TE component 706 and the TM component 705.

Structures that include such a polarization separation film have been specifically suggested. One example is a waveguide-type polarization separation multiplexing device having a configuration in which a polarization separation film is arranged in a position where two optical waveguides intersect with each other (Patent literature 1), similar to the above configuration. Another example is an optical waveguide device including a polarizer arranged at an end of the optical waveguide device on which signal light is incident as a device that handles optical signals (Patent literature 2).

### CITATION LIST

### Patent Literature

PTL1: Japanese Unexamined Patent Application Publication No. 10-221555

PTL2: Japanese Unexamined Patent Application Publication No. 4-282608

### Non Patent Literature

NPTL1: N. Keil, et al., “Polymer PLC as an Optical Integration Bench”, Technical Digest of OFC 2011, OWM1

### SUMMARY OF INVENTION

### Technical Problem

The present inventor has found, however, that there is a problem in the polarization separation system shown in FIG. 6. One advantage of this system is that it is possible to easily arrange the polarization separation film 702 in the optical waveguide. According to this system, however, the optical waveguide is cut off in the position where the polarization separation film 702 is arranged. This causes diffraction at the position where the optical waveguide is cut off, which causes a diffraction loss. Further, the angle of the light incident on the polarization separation film 702 is widened due to the diffraction, which causes a reduction in polarization separation characteristics and a reduction in polarization extinguish ratio.

The present invention has been made in view of the aforementioned background, and an exemplary object of the present invention is to provide a polarization separator, a polarization separation structure, an optical mixer, and a method for manufacturing the polarization separator having excellent polarization separation characteristics.

### Solution to Problem

A polarization separator according to one exemplary aspect of the present invention includes: a substrate; an analyzer that emits a linearly polarized light including a first polarization signal and a second polarization signal included in an incident light, the second polarization signal being different from the first polarization signal, and the intensity of the first polarization signal and the intensity of the second polarization signal being equal to each other; a polarization separation film arranged on the substrate, the polarization separation film performing polarization separation on the linearly polarized light by transmitting the first polarization signal and reflecting the second polarization signal; a first optical waveguide formed on the substrate, an end surface of the first optical waveguide being opposed to a first surface of the polarization separation film, and a waveguide direction of the first optical waveguide being a direction in which the first polarization signal propagates; and a second optical waveguide formed on the substrate, an end surface of the second optical waveguide being opposed to a second surface which is a surface opposite to the first surface of the polarization separation film, and a waveguide direction of the second optical waveguide being a direction in which the second polarization signal propagates.

An optical mixer according to one exemplary aspect of the present invention includes: a first polarization separator that receives a condensed polarization-multiplexed signal light and performs polarization separation to separate the polarization-multiplexed signal light into a first polarization signal and a second polarization signal, the first polarization signal and the second polarization signal having polarization planes different from each other; and an optical interference device that separates phases of the first polarization signal and the second polarization signal, in which the first polarization separator includes: a substrate; a first analyzer that emits a first linearly polarized light including the first polarization signal and the second polarization signal included in an incident light, the intensity of the first polarization signal and the intensity of the second polarization signal being equal to each other; a first polarization separation film arranged on the substrate, the first polarization separation film performing polarization separation on the linearly polarized light by transmitting the first polarization signal and reflecting the second polarization signal; a first optical waveguide formed on the substrate and connected to the optical interference device, an end surface of the first optical waveguide being opposed to a first surface of the first polarization separation film, and a waveguide direction of the first optical waveguide being a direction in which the first polarization signal propagates; and a second optical waveguide formed on the substrate and connected to the optical interference device, an end surface of the second optical waveguide being opposed to a second surface which is a surface opposite to the first surface of the first polarization separation film, and a waveguide direction of the second optical waveguide being a direction in which the second polarization signal propagates.

A method for manufacturing a polarization separator according to one exemplary aspect of the present invention includes: arranging an analyzer that emits a linearly polarized light including a first polarization signal and a second polarization signal included in an incident light, the second polarization signal being different from the first polarization signal, the intensity of the first polarization signal and the intensity of the second polarization signal being equal to each other, and the linearly polarized light being polarized and separated into the first polarization signal and the second polarization signal by a polarization separation film; arranging the polarization separation film on a substrate so that the linearly polarized light is incident on the polarization separation film, the polarization separation film performing polarization separation on the linearly polarized light by transmitting the first polarization signal and reflecting the second polarization signal; forming a first optical waveguide on the substrate before the polarization separation film is arranged, an end surface of the first optical waveguide being opposed to a first surface of the polarization separation film, and a waveguide direction of the first optical waveguide being a direction in which the first polarization signal propagates, and forming a second optical waveguide on the substrate before the polarization separation film is arranged, an end surface of the second optical waveguide being opposed to a second surface which is a surface opposite to the first surface of the polarization separation film, and a waveguide direction of the second optical waveguide being a direction in which the second polarization signal propagates.

### Advantageous Effects of Invention

According to the present invention, it is possible to provide a polarization separator, a polarization separation structure, an optical mixer, and a method for manufacturing the polarization separator having excellent polarization separation characteristics.

### BRIEF DESCRIPTION OF DRAWINGS

FIG. 1 is a configuration diagram schematically showing a plane configuration of a polarization separator 100 according to a first exemplary embodiment;

FIG. 2 is a perspective view schematically showing a configuration of the polarization separator 100 according to the first exemplary embodiment;

FIG. 3 is a configuration diagram schematically showing a plane configuration of a polarization separation structure 200 according to a second exemplary embodiment;

FIG. 4 is a configuration diagram schematically showing a plane configuration of an optical mixer 300 according to a third exemplary embodiment;

FIG. 5 is a configuration diagram schematically showing a plane configuration of an optical mixer 400 according to a fourth exemplary embodiment; and

FIG. 6 is a configuration diagram showing an arrangement of an optical waveguide and a polarization separation film when the polarization separation film is arranged in the optical waveguide to perform polarization separation.

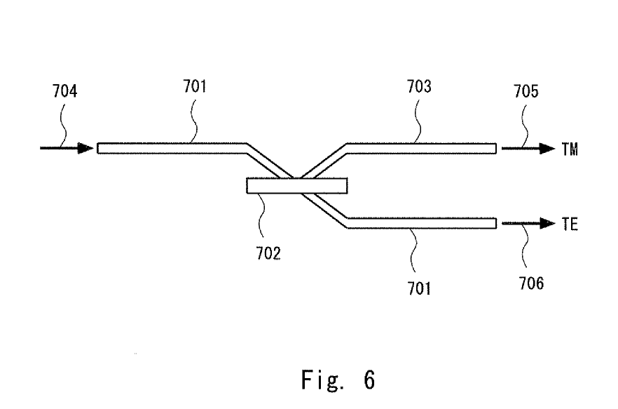

### DESCRIPTION OF EMBODIMENTS

### EXAMPLE 1

Hereinafter, with reference to the drawings, exemplary embodiments of the present invention will be described. Throughout the drawings, the same components are denoted by the same reference symbols and the overlapping descriptions will be omitted as needed.

### First Exemplary Embodiment

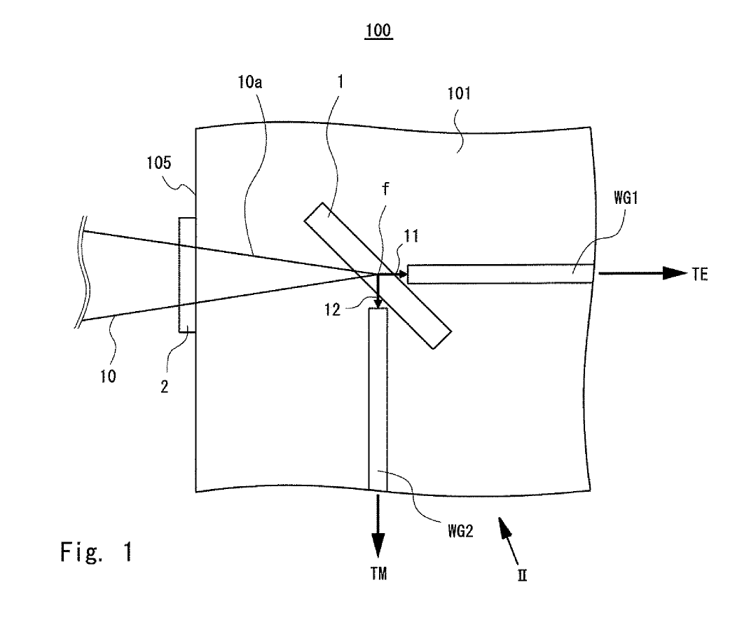

First, a polarization separator 100 according to a first exemplary embodiment of the present invention will be described. FIG. 1 is a configuration diagram schematically showing a plane configuration of the polarization separator 100 according to the first exemplary embodiment. The polarization separator 100 includes a polarization separation film 1, an analyzer 2, and optical waveguides WG1 and WG2.

An end surface of the optical waveguide WG1 is contacted to the polarization separation film 1 or is arranged in proximity to the polarization separation film 1. In a similar way, an end surface of the optical waveguide WG2 is contacted to the polarization separation film 1 or is arranged in proximity to the polarization separation film 1. As will be described later, the optical waveguides WG1 and WG2 are formed on a substrate 101. The analyzer 2 is arranged on the side of a light-incident end surface 105 with respect to the polarization separation film 1.

A light 10 condensed by condensing means such as a lens is incident on the analyzer 2. The light 10 is, for example, a polarization-multiplexed signal light. The analyzer 2 transmits only a linearly polarized light 10a with an oblique angle of 45° of the light 10. Specifically, the analyzer 2 emits the linearly polarized light 10a whose deflected surface has an angle of 45°, which is the angle intermediate to a TE component and a TM component of the light 10 whose polarization planes are perpendicular to each other. The linearly polarized light 10a is incident on the polarization separation film 1 through the light-incident end surface 105. That is, the intensity of the TM component and the intensity of the TE component of the light 10 included in the linearly polarized light 10a that reaches the polarization separation film 1 are made equal by the analyzer 2. The linearly polarized light 10a is condensed within a predetermined distance from the end surface of the optical waveguide WG1 and the end surface of the optical waveguide WG2 and is separated into a TE light 11 and a TM light 12 by the polarization separation film 1.

The TE light 11 transmits through the polarization separation film 1 and is incident on the optical waveguide WG1. At this time, since a focal point f of the linearly polarized light 10a is within a predetermined distance from the end surface of the optical waveguide WG1, the TE light 11 is incident on the optical waveguide WG1 as a condensed beam. The phrase “within a predetermined distance” means a distance in which the condensed area of the condensed beam is within the end surface of the optical waveguide WG1. The TE light 11 therefore can be optically coupled to the optical waveguide WG1 at low loss.

The TM light 12 is reflected by the polarization separation film 1 and is incident on the optical waveguide WG2. At this time, since the focal point f of the linearly polarized light 10a is within a predetermined distance from the end surface of the optical waveguide WG2, the TM light 12 is incident on the optical waveguide WG2 as a condensed beam. The phase “within a predetermined distance” means a distance in which the condensed area of the condensed beam is within the end surface of the optical waveguide WG2. Accordingly, the TM light 12 can be optically coupled to the optical waveguide WG2 at low loss.

Further, the polarization separator 100 causes the linearly polarized light 10a having a polarization plane with an oblique angle of 45° to be incident on the polarization separation film 1 by the analyzer 2, as described above. It is therefore possible to uniform the intensity ratio of the TE light 11 and the TM light 12 when the linearly polarized light 10a is separated into the TE light 11 and the TM light 12 by the polarization separation film 1.

In the following description, a case in which the light 10 is directly incident on the polarization separation film 1 without the use of the analyzer 2 will be described in order to clarify the technical significance of the analyzer 2. In a communication system of a DP-QPSK system, for example, a polarization-multiplexed signal light is used as the light 10. In order to keep the polarization state of the polarization-multiplexed signal light, the light 10 propagates through, for example, a polarization plane preserving fiber to be incident on the polarization separator 100.

Even when the polarization plane preserving fiber is used, however, the angle of the polarization plane of the light 10 fluctuates by about ±10° and elliptical polarization components are mixed. When the light 10 in which the polarization plane has been fluctuated is separated by the polarization separation film 1, this cases temporal fluctuations of the intensity ratio of the TE light 11 and the TM light 12. Since the fluctuations of the polarization plane depend on the temperature or the wavelength of the light 10, the fluctuations of the intensity ratio of the TE light 11 and the TM light 12 are further enlarged due to changes in temperature or a difference in wavelengths.

Meanwhile, the analyzer 2 is used in the polarization separator 100. Accordingly, even when fluctuations of the polarization plane of the light 10 occur, it is possible to cause the linearly polarized light 10a having a polarization plane with an oblique angle of 45° to be incident on the polarization separation film 1. It is therefore possible to stably uniform the intensity ratio of the TE light 11 and the TM light 12 even when fluctuations of the polarization plane of the light 10 occur.

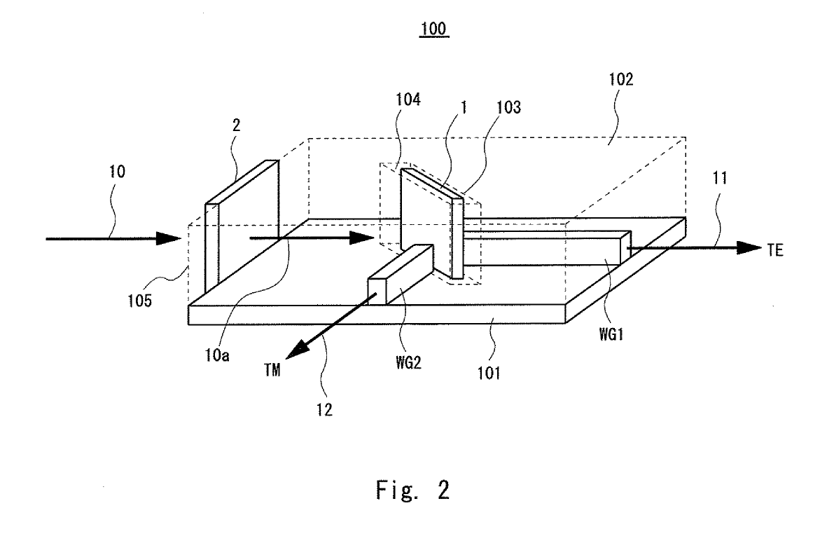

Next, a solid configuration of the polarization separator 100 will be described. FIG. 2 is a perspective view schematically showing a configuration of the polarization separator 100 according to the first exemplary embodiment. FIG. 2 is a perspective view of the polarization separator 100 when seen from the direction II in FIG. 1. The optical waveguides WG1 and WG2 are formed on the substrate 101 by, for example, a Chemical Vapor Deposition (CVD). A silicon substrate is used, for example, as the substrate 101. The optical waveguides WG1 and WG2 are formed of, for example, SiO₂.

A clad layer 102 is formed on the optical waveguides WG1 and WG2 and the substrate 101. In FIG. 2, the clad layer 102 is shown by the dashed line for the purpose of clarity. Core layers of the optical waveguides WG1 and WG2 have a refractive index higher than that of the clad layer 102 by, for example, about 1.5%, whereby light is confined in the two-dimensional direction.

In the clad layer 102, a groove 103 is formed at a position where the polarization separation film 1 is arranged. The groove 103 is formed to have a dimension larger than that of the polarization separation film 1 so as to be able to contain the polarization separation film 1. The groove 103 is formed by etching (e.g., Bosch process). The groove 103 has a depth, for example, from the upper surface of the clad layer 102 to the substrate 101. The depth of the groove 103 is, for example, 150 μm.

The polarization separation film 1 is placed into the groove 103. A gap 104 between the polarization separation film 1 and side surfaces of the groove 103 is filled with adhesive which is refractive-index-matched to the effective refractive index of the optical waveguides WG1 and WG2. The polarization separation film 1 is thus fixed.

The analyzer 2 is arranged in contact with the light-incident end surface 105 of the clad layer 102. It is not necessary that the analyzer 2 contacts with the light-incident end surface 105 and may be arranged on the side on which the light 10 is incident with respect to the polarization separation film 1. In this state, the light 10 is incident on the analyzer 2, and the analyzer 2 emits the linearly polarized light 10a. The linearly polarized light 10a is incident on the polarization separation film 1 through the light-incident end surface 105.

In summary, since the linearly polarized light 10a is condensed at a vicinity of the end surfaces of the optical waveguides WG1 and WG2 in the polarization separator 100, diffraction of the linearly polarized light 10a can be suppressed. It is therefore possible to reduce the loss due to diffraction. In addition, since the linearly polarized light 10a can be made incident on the polarization separation film 1 in a state close to that of collimated light, the polarization separation characteristics can further be improved.

Further, the polarization separator 100 optimizes the position on which the linearly polarized light 10a is incident by adjusting the optical axis, whereby it is possible to uniform the intensity of the TE light and the intensity of the TM light after the polarization separation. This effect cannot be achieved by the system in which a polarization separation film is arranged in a waveguide and can be achieved only by the polarization separator 100. Further, as described above, the polarization separator 100 is able to uniform the intensity ratio of the TE light 11 and the TM light 12 by the analyzer 2 more stably.

Described in this exemplary embodiment is the polarization separation film 1 that transmits the TE light 11 and reflects the TM light 12. The same operation of polarization separation may be achieved also in the polarization separation film 1 that reflects the TE light 11 and transmits the TM light 12.

### Second Exemplary Embodiment

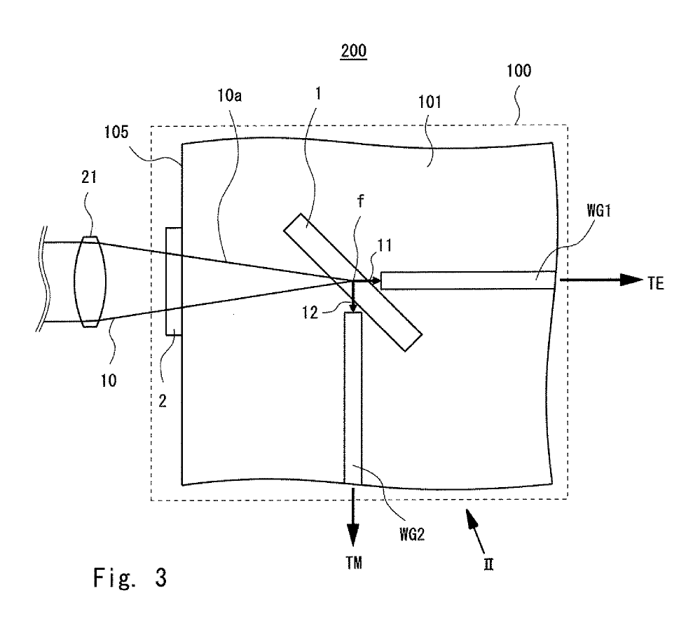

Next, a polarization separation structure 200 according to a second exemplary embodiment of the present invention will be described. FIG. 3 is a configuration diagram schematically showing a plane configuration of the polarization separation structure 200 according to the second exemplary embodiment. The polarization separation structure 200 further includes a lens 21 which is condensing means added to the polarization separator 100 according to the first exemplary embodiment.

The lens 21 condenses, as shown in FIG. 3, an extraneous light 10. This allows the linearly polarized light 10a that is condensed to be incident on the polarization separation film 1, as described in the first exemplary embodiment.

While the lens 21 is a biconvex lens in FIG. 3, other lenses than the biconvex lens may naturally be used. Alternatively, other optical elements such as a concave mirror may be used as the condensing means in place of the lens as long as the optical element is able to condense the light 10.

While the analyzer 2 is arranged between the lens 21 and the light-incident end surface 105 in FIG. 3, it is merely an example. The lens 21 may be arranged, for example, between the analyzer 2 and the light-incident end surface 105.

### Third Exemplary Embodiment

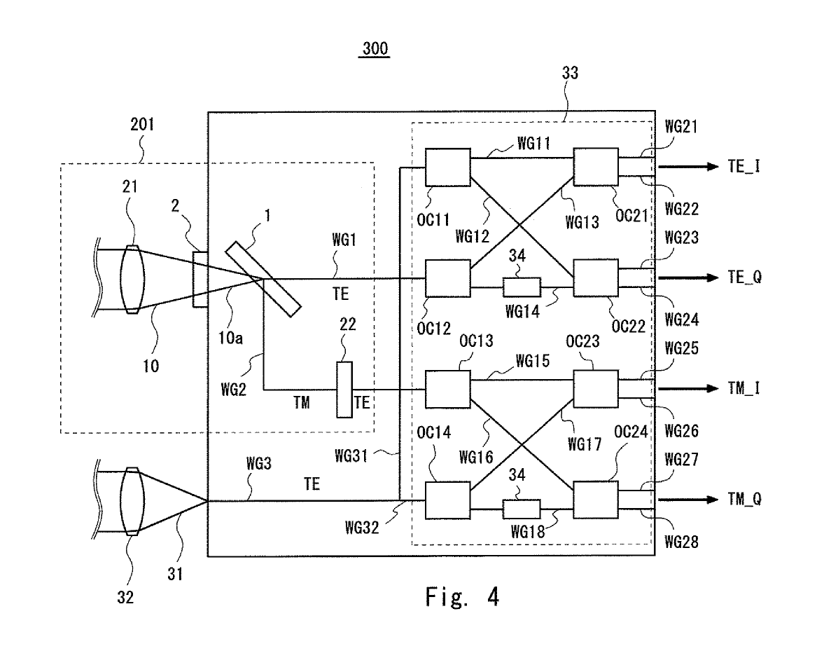

Next, an optical mixer 300 according to a third exemplary embodiment of the present invention will be described. FIG. 4 is a configuration diagram schematically showing a plane configuration of the optical mixer 300 according to the third exemplary embodiment. The optical mixer 300 carries out polarization separation and phase separation of DP-QPSK signals. In the following description, the light 10 is a DP-QPSK signal. The optical mixer 300 includes a polarization separation structure 201, a lens 32, an interference unit 33, and optical waveguides WG3, WG31, and WG32. FIG. 4 schematically shows the optical waveguides WG3, WG31, and WG32 by lines.

The interference unit 33 includes optical couplers OC11 to OC14 and OC21 to OC24 and optical waveguides WG11 to WG18 and WG21 to WG28. FIG. 4 schematically shows the optical waveguides WG11 to WG18 and WG21 to WG28 by lines.

The optical couplers OC to OC14 are so-called directional couplers or Y branch waveguides, and each of the optical couplers OC11 to OC14 splits light into two light beams to output the light beams that are output from each of two output ports in the same phase. The optical couplers OC21 to OC24 are so-called optical directional couplers, and each of the optical couplers OC21 to OC24 outputs light obtained by multiplexing two light beams in the reverse phase from each of the two output ports.

One output port of the optical coupler OC11 is connected to one input port of the optical coupler OC21 through the optical waveguide WG11. The other output port of the optical coupler OC11 is connected to one input port of the optical coupler OC22 through the optical waveguide WG12. One output port of the optical coupler OC12 is connected to the other input port of the optical coupler OC21 through the optical waveguide WG13. The other output port of the optical coupler OC12 is connected to the other input port of the optical coupler OC22 through the optical waveguide WG14.

One output port of the optical coupler OC13 is connected to one input port of the optical coupler OC23 through the optical waveguide WG15. The other output port of the optical coupler OC13 is connected to one input port of the optical coupler OC24 through the optical waveguide WG16. One output port of the optical coupler OC14 is connected to the other input port of the optical coupler OC23 through the optical waveguide WG17. The other output port of the optical coupler OC14 is connected to the other input port of the optical coupler OC24 through the optical waveguide WG18.

The optical waveguides WG14 and WG18 include a phase delay means 34 which delays the optical phase by π/2. In order to delay the optical phase by π/2, the optical path length of the optical waveguide may be increased by a quarter of the optical wavelength, for example.

The two output ports of the optical coupler OC21 are connected to the optical waveguides WG21 and WG22. The two output ports of the optical coupler OC22 are connected to the optical waveguides WG23 and WG24. The two output ports of the optical coupler OC23 are connected to the optical waveguides WG25 and WG26. The two output ports of the optical coupler OC24 are connected to the optical waveguides WG27 and WG28.

The polarization separation structure 201 further includes a half-wave plate (λ/2 plate) 22 added to the polarization separation structure 200 according to the second exemplary embodiment. The optical waveguide WG1 is connected to the input port of the optical coupler OC12. The optical waveguide WG2 is connected to the input port of the optical coupler OC13. The half-wave plate 22 is provided in the optical waveguide WG2 arranged between the input of the optical coupler OC13 and the polarization separation film 1. FIG. 4 schematically shows the optical waveguides WG1 and WG2 by lines.

The polarization separation structure 201 polarizes and separates the light 10 into the TE light 11 and the TM light 12. The TE light 11 is input to the optical coupler OC12. The TM light 12 is converted into a TE light 13 by the half-wave plate 22. The TE light 13 is input to the optical coupler OC13. Since the operation of the polarization separation structure 201 is similar to that of the polarization separation structure 200, the description will be omitted.

A local light 31 is incident on the optical waveguide WG3 through the lens 32 from outside. The local light 31 may be, for example, a TE component of the light output from an external laser diode (LD). The optical waveguide WG3 is split into the optical waveguides WG31 and WG32. The optical waveguide WG31 is /connected to the input port of the optical coupler OC11. The optical waveguide WG32 is connected to the input port of the optical coupler OC14. In summary, the local light 31 which is the TE light is input to the optical couplers OC11 and OC14.

Accordingly, in the interference unit 33, TE_I (0°), which is the in-phase (I) component of the QPSK signal included in the TE component of the light 10 is output from the optical waveguide WG21 or WG22. TE_Q (90°), which is the quadrature-phase (Q) component of the QPSK signal included in the TE component of the light 10 is output from the optical waveguide WG23 or WG24. Further, TM_I (0°), which is the I component of the QPSK signal included in the TM component of the light 10 is output from the optical waveguide WG25 or WG26. TM_Q (90°), which is the Q component of the QPSK signal included in the TM component of the light 10 is output from the optical waveguide WG27 or WG28.

According to the configuration, excellent polarization separation is performed at low loss, and it is possible to obtain a highly efficient optical mixer that exhibits low losses and high polarization extinguish ratio. Further, the polarization separation structure and the interference device may be integrally formed on a substrate, which allows a reduction in size.

### Fourth Exemplary Embodiment

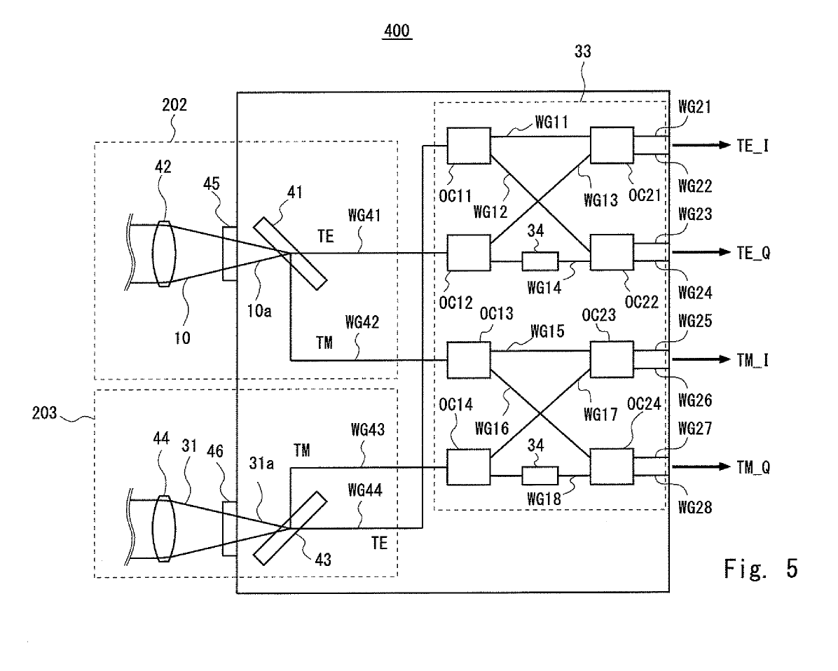

Next, an optical mixer 400 according to a fourth exemplary embodiment of the present invention will be described. FIG. 5 is a configuration diagram schematically showing a plane configuration of the optical mixer 400 according to the fourth exemplary embodiment. The optical mixer 400 carries out polarization separation and phase separation of DP-QPSK signals. In the following description, the light 10 is a DP-QPSK signal. The optical mixer 400 includes polarization separation structures 202 and 203 and an interference unit 33.

Since the interference unit 33 is similar to that of the third exemplary embodiment, the description will be omitted.

The polarization separation structures 202 and 203 have a configuration similar to that of the polarization separation structure 201 according to the second exemplary embodiment.

The polarization separation structure 202 includes a polarization separation film 41, a lens 42, an analyzer 45, and optical waveguides WG41 and WG42. The polarization separation film 41 corresponds to the polarization separation film 1 of the polarization separation structure 200. The lens 42 corresponds to the lens 21 of the polarization separation structure 200. The analyzer 45 corresponds to the analyzer 2 of the polarization separation structure 200. The optical waveguides WG41 and WG42 correspond to the optical waveguides WG1 and WG2 of the polarization separation structure 200, respectively. The optical waveguide WG41 is connected to the input port of the optical coupler OC12. The optical waveguide WG42 is connected to the input port of the optical coupler OC13. FIG. 5 schematically shows the optical waveguides WG41 and WG42 by lines.

The polarization separation structure 202 polarizes and separates the light 10 into the TE light 11 and the TM light 12. The TE light 11 is input to the optical coupler OC12. The TM light 12 is input to the optical coupler OC13. Since the operation of the polarization separation structure 202 is similar to that of the polarization separation structure 200, the description thereof will be omitted.

The polarization separation structure 203 includes a polarization separation film 43, a lens 44, an analyzer 46, and optical waveguides WG43 and WG44. The polarization separation film 43 corresponds to the polarization separation film 1 of the polarization separation structure 200. The lens 44 corresponds to the lens 21 of the polarization separation structure 200. The analyzer 46 corresponds to the analyzer 2 of the polarization separation structure 200. The optical waveguides WG43 and WG44 correspond to the optical waveguides WG1 and WG2 of the polarization separation structure 200, respectively. The optical waveguide WG43 is connected to the input port of the optical coupler OC11. The optical waveguide WG44 is connected to the input port of the optical coupler OC14. FIG. 5 schematically shows the optical waveguides WG43 and WG44 by lines.

The local light 31 is light including a TE component and a TM component. The lens 44 condenses the local light 31 to cause the local light 31 to be incident on the analyzer 46. The analyzer 46 emits a linearly polarized light 31a with an oblique angle of 45° of the local light 31. Specifically, the analyzer 46 emits the linearly polarized light 31a whose deflected surface has an angle of 45° , which is the angle intermediate to the TE component and the TM component of the local light 31 whose polarization planes are perpendicular to each other. The linearly polarized light 31 a is incident on the polarization separation film 43 through the light-incident end surface 105. In summary, due to the presence of the analyzer 46, the intensity of the TM component and the intensity of the TE component of the local light 31 included in the linearly polarized light 31a that reaches the polarization separation film 43 are made equal to each other.

The linearly polarized light 31a is condensed within a predetermined distance from the end surface of the optical waveguide WG43 and the end surface of the optical waveguide WG44. The linearly polarized light 31a is separated into the local TE light and the local TM light by the polarization separation film 43. The local TM light propagates through the optical waveguide WG43 and the local TE light propagates through the optical waveguide WG43 to reach the interference unit 33. The local TE light is input to the optical coupler OC11. The local TM light is input to the optical coupler OC14.

Accordingly, in the interference unit 33, similar to the third exemplary embodiment, TE_I (0°), which is the I component of the QPSK signal included in the TE component of the light 10 is output from the optical waveguide WG21 or WG22. TE_Q (90°), which is the Q component of the QPSK signal included in the TE component of the light 10 is output from the optical waveguide WG23 or WG24. Further, TM_I (0°), which is the I component of the QPSK signal included in the TM component of the light 10 is output from the optical waveguide WG25 or WG26. TM_Q (90°), which is the Q component of the QPSK signal included in the TM component of the light 10 is output from the optical waveguide WG27 or WG28.

As described above, according to this configuration, similar to the third exemplary embodiment, it is possible to obtain a small-sized highly efficient optical mixer that exhibits low losses and high polarization extinguish ratio. According to this configuration, it is possible to uniform the intensity ratio of the local TE light and the local TM light when the local light 31 is polarized and separated. It is therefore possible to separate the DP-QPSK signal in a more uniform way.

The present invention is not limited to the exemplary embodiments stated above and may be changed as appropriate without departing from the spirit of the present invention. For example, while the case of using the DP-QPSK signal has been described in the above third and fourth exemplary embodiments, the optical signal multiplex system is not limited to this case. Other multiplex systems than the QPSK may be used as appropriate as long as polarization multiplexing is carried out.

While the case of using the polarization separation structure has been described in the third and fourth exemplary embodiments, the polarization separation structure may be appropriately replaced with the polarization separator according to the first exemplary embodiment.

While the configuration in which the extraneous light is incident on the condensing means and the analyzer is arranged between the lens and the polarization separation film has been described in the above exemplary embodiments, this configuration is merely an example. As long as the linearly polarized light is incident on the polarization separation film, the extraneous light may be incident on the analyzer and the condensing means may be arranged between the analyzer and the polarization separation film. Considering simplification of the structure and ease of angle retention, it is desirable that the analyzer is arranged to be contact with the light-incident end surface.

While a part or all of the aforementioned exemplary embodiments may be described as shown in the following Supplementary notes, it is not limited to them.
(Supplementary note 1) A polarization separator comprising: a substrate; an analyzer that emits a linearly polarized light including a first polarization signal and a second polarization signal included in an incident light, the second polarization signal being different from the first polarization signal, and the intensity of the first polarization signal and the intensity of the second polarization signal being equal to each other; a polarization separation film arranged on the substrate, the polarization separation film performing polarization separation on the linearly polarized light by transmitting the first polarization signal and reflecting the second polarization signal; a first optical waveguide formed on the substrate, an end surface of the first optical waveguide being opposed to a first surface of the polarization separation film, and a waveguide direction of the first optical waveguide being a direction in which the first polarization signal propagates; and a second optical waveguide formed on the substrate, an end surface of the second optical waveguide being opposed to a second surface which is a surface opposite to the first surface of the polarization separation film, and a waveguide direction of the second optical waveguide being a direction in which the second polarization signal propagates.
(Supplementary note 2) The polarization separator according to Supplementary note 1, wherein the linearly polarized light comprises a polarization plane which is between a polarization plane of the first polarization signal and a polarization plane of the second polarization signal.
(Supplementary note 3) The polarization separator according to Supplementary note 2, wherein the polarization plane of the first polarization signal is perpendicular to the polarization plane of the second polarization signal, and the polarization plane of the linearly polarized light is a plane obtained by rotating the polarization plane of the first polarization signal and the polarization plane of the second polarization signal by 45°.
(Supplementary note 4) The polarization separator according to any one of Supplementary notes 1 to 3, wherein the linearly polarized light that is condensed is incident on the polarization separation film, and the first optical waveguide and the second optical waveguide are arranged closer to a focal point of the condensed linearly polarized light than a distance in which the condensing plane of the linearly polarized light is within the end surface of the first optical waveguide and the end surface of the second optical waveguide.
(Supplementary note 5) The polarization separator according to Supplementary note 4, wherein polarization-multiplexed signal light is incident on the analyzer.
(Supplementary note 6) A polarization separation structure comprising: the polarization separator according to Supplementary note 4 or 5, and condensing means for condensing an incident light and focusing the incident light at a distance in which a condensing plane of the condensed light is within the end surface of the first optical waveguide and the end surface of the second optical waveguide, wherein the analyzer emits the linearly polarized light to the condensing means.
(Supplementary note 7) A polarization separation structure comprising: the polarization separator according to Supplementary note 4; and condensing means for condensing an incident light and focusing the incident light at a distance in which a condensing plane of the condensed light is within the end surface of the first optical waveguide and the end surface of the second optical waveguide, wherein the analyzer is provided between the condensing means and the polarization separation film.
(Supplementary note 8) The polarization separation structure according to Supplementary note 7, wherein polarization-multiplexed signal light is incident on the condensing means.
(Supplementary note 9) An optical mixer comprising: a first polarization separator that receives a condensed polarization-multiplexed signal light and performs polarization separation to separate the polarization-multiplexed signal light into a first polarization signal and a second polarization signal, the first polarization signal and the second polarization signal having polarization planes different from each other; and an optical interference device that separates phases of the first polarization signal and the second polarization signal, wherein the first polarization separator comprises: a substrate; a first analyzer that emits a first linearly polarized light including the first polarization signal and the second polarization signal included in an incident light, the intensity of the first polarization signal and the intensity of the second polarization signal being equal to each other; a first polarization separation film arranged on the substrate, the first polarization separation film performing polarization separation on the linearly polarized light by transmitting the first polarization signal and reflecting the second polarization signal; a first optical waveguide formed on the substrate and connected to the optical interference device, an end surface of the first optical waveguide being opposed to a first surface of the first polarization separation film, and a waveguide direction of the first optical waveguide being a direction in which the first polarization signal propagates; and a second optical waveguide formed on the substrate and connected to the optical interference device, an end surface of the second optical waveguide being opposed to a second surface which is a surface opposite to the first surface of the first polarization separation film, and a waveguide direction of the second optical waveguide being a direction in which the second polarization signal propagates.
(Supplementary note 10) The optical mixer according to Supplementary note 9, wherein the first linearly polarized light comprises a polarization plane which is between a polarization plane of the first polarization signal and a polarization plane of the second polarization signal.
(Supplementary note 11) The optical mixer according to Supplementary note 10, wherein the polarization plane of the first polarization signal is perpendicular to the polarization plane of the second polarization signal, and the polarization plane of the first linearly polarized light is a plane obtained by rotating the polarization plane of the first polarization signal and the polarization plane of the second polarization signal by 45°.
(Supplementary note 12) The optical mixer according to any one of Supplementary notes 9 to 11, wherein the first linearly polarized light that is condensed is incident on the first polarization separation film, and the first optical waveguide and the second optical waveguide are arranged closer to a focal point of the condensed first linearly polarized light than a distance in which a condensing plane of the first linearly polarized light is within the end surface of the first optical waveguide and the end surface of the second optical waveguide.
(Supplementary note 13) The optical mixer according to Supplementary note 12, wherein the polarization-multiplexed signal light is incident on the first analyzer.
(Supplementary note 14) The optical mixer according to Supplementary note 12 or 13, further comprising a first condensing means for condensing an incident light and focusing the incident light at a distance in which a condensing plane of the condensed light is within the end surface of the first optical waveguide and the end surface of the second optical waveguide, wherein the first analyzer emits the first linearly polarized light to the first condensing means.
(Supplementary note 15) The optical mixer according to Supplementary note 12, further comprising a first condensing means for condensing an incident light and focusing the incident light at a distance in which a condensing plane of the condensed light is within the end surface of the first optical waveguide and the end surface of the second optical waveguide, wherein the first analyzer is arranged between the first condensing means and the polarization separation film.
(Supplementary note 16) The optical mixer according to Supplementary note 15, wherein the polarization-multiplexed signal light is incident on the first condensing means.
(Supplementary note 17) The optical mixer according to any one of Supplementary notes 10 to 16, wherein the optical interference device interferes each of the first and second polarization signals separated by the polarization separation performed by the first polarization separation film with a local light, and outputs two signal light beams having phases different from each other by π/2 from each of the first and second polarization signals.
(Supplementary note 18) The optical mixer according to Supplementary note 17, wherein the local light is separated into a first local light and a second local light, and the optical mixer interferes the first polarization signal with the first local light and interferes the second polarization signal with the second local light.
(Supplementary note 19) The optical mixer according to Supplementary note 18, wherein the first local light has a polarization plane same as that of the first polarization signal and the second local light has a polarization plane same as that of the second polarization signal.
(Supplementary note 20) The optical mixer according to Supplementary note 19, further comprising polarization plane rotating means arranged in the second optical waveguide, the polarization plane rotating means rotating a polarization plane of the second polarization signal to make the polarization plane of the second polarization signal coincide with the polarization plane of the first local light.
(Supplementary note 21) The optical mixer according to Supplementary note 20, wherein the first polarization signal is a TE light, the second polarization signal is a TM light, the first local light and the second local light are a TE light, and the polarization plane rotating means is a half-wave plate.
(Supplementary note 22) The optical mixer according to Supplementary note 21, wherein the first polarization separator, the first condensing means, and the half-wave plate form a first polarization separation structure.
(Supplementary note 23) The optical mixer according to Supplementary note 17, wherein the local light is performed polarization separation to separate the local light into a first local light having a polarization plane same as that of the first polarization signal and a second local light having a polarization plane same as that of the second polarization signal.
(Supplementary note 24) The optical mixer according to Supplementary note 23, further comprising a second polarization separator that performs polarization separation to separete the local light into the first local light and the second local light, wherein the second polarization separator comprises: a second polarization separation film arranged on the substrate, the second polarization separation film performing polarization separation on the local light by transmitting the first local light and reflecting the second local light; a third optical waveguide formed on the substrate and connected to the optical interference device, an end surface of the third optical waveguide being opposed to a third surface of the second polarization separation film, and a waveguide direction of the third optical waveguide being a direction in which the first local light propagates; and a fourth optical waveguide formed on the substrate and connected to the optical interference device, an end surface of the fourth optical waveguide being opposed to a fourth surface which is a surface opposite to the third surface of the second polarization separation film, and a waveguide direction of the fourth optical waveguide being a direction in which the second local light propagates.
(Supplementary note 25) The optical mixer according to Supplementary note 24, wherein the third optical waveguide and the fourth optical waveguide are arranged closer to a focal point of the condensed local light than a distance in which the condensing plane of the local light is within the end surface of the third optical waveguide and the end surface of the fourth optical waveguide.
(Supplementary note 26) The optical mixer according to Supplementary note 25, further comprising a second condensing means for condensing the local light and focusing the local light at a distance in which the condensing plane of the local light is within the end surface of the third optical waveguide and the end surface of the fourth optical waveguide, wherein the second polarization separator and the second condensing means form a second polarization separation structure.
(Supplementary note 27) The optical mixer according to Supplementary note 23, further comprising a second polarization separator that performs polarization separation to separate the local light into the first local light and the second local light, wherein the second polarization separator comprises: a second analyzer that emits a second linearly polarized light including the first local light and the second local light included in the incident local light, the intensity of the first local light and the intensity of the second local light being equal to each other; a second polarization separation film arranged on the substrate, the second polarization separation film performing polarization separation on the local light by transmitting the second local light and reflecting the second local light; a third optical waveguide formed on the substrate and connected to the optical interference device, an end surface of the third optical waveguide being opposed to a third surface of the second polarization separation film, and a waveguide direction of the third optical waveguide being a direction in which the first local light propagates; and a fourth optical waveguide formed on the substrate and connected to the optical interference device, an end surface of the fourth optical waveguide being opposed to a fourth surface which is a surface opposite to the third surface of the second polarization separation film, and a waveguide direction of the fourth optical waveguide being a direction in which the second local light propagates.
(Supplementary note 28) The optical mixer according to Supplementary note 27, wherein the second linearly polarized light comprises a polarization plane which is between a polarization plane of the first local light and a polarization plane of the second local light.
(Supplementary note 29) The optical mixer according to Supplementary note 28, wherein the polarization plane of the first local light is perpendicular to the polarization plane of the second local light, and the polarization plane of the second linearly polarized light is a plane obtained by rotating the polarization plane of the first local light and the polarization plane of the second local light by 45°.
(Supplementary note 30) The optical mixer according to any one of Supplementary notes 27 to 29, wherein the second linearly polarized light that is condensed is incident on the second polarization separation film, and the third optical waveguide and the fourth optical waveguide are arranged closer to a focal point of the condensed second linearly polarized light than a distance in which a condensing plane of the second linearly polarized light is within the end surface of the third optical waveguide and the end surface of the fourth optical waveguide.
(Supplementary note 31) The optical mixer according to Supplementary note 30, further comprising a second condensing means for condensing the second linearly polarized light that is incident on the second condensing means and focusing the incident second linearly polarized light at a distance in which the condensing plane of the condensed second linearly polarized light is within the end surface of the third optical waveguide and the end surface of the fourth optical waveguide, wherein the second analyzer emits the second linearly polarized light to the second condensing means.
(Supplementary note 32) The optical mixer according to Supplementary note 30, further comprising a second condensing means for condensing the local light that is incident on the second condensing means and focusing the incident local light at a distance in which the condensing plane of the condensed local light is within the end surface of the third optical waveguide and the end surface of the third optical waveguide, wherein the second analyzer is arranged between the second condensing means and the second polarization separation film.
(Supplementary note 33) The optical mixer according to Supplementary note 31 or 32, wherein the second polarization separator and the second condensing means form a second polarization separation structure.
(Supplementary note 34) A method for manufacturing a polarization separator comprising: arranging an analyzer that emits a linearly polarized light including a first polarization signal and a second polarization signal included in an incident light, the second polarization signal being different from the first polarization signal, the intensity of the first polarization signal and the intensity of the second polarization signal being equal to each other, and the linearly polarized light being polarized and separated into the first polarization signal and the second polarization signal by a polarization separation film; arranging the polarization separation film on a substrate so that the linearly polarized light is incident on the polarization separation film, the polarization separation film performing polarization separation on the linearly polarized light by transmitting the first polarization signal and reflecting the second polarization signal; forming a first optical waveguide on the substrate before the polarization separation film is arranged, an end surface of the first optical waveguide being opposed to a first surface of the polarization separation film, and a waveguide direction of the first optical waveguide being a direction in which the first polarization signal propagates, and forming a second optical waveguide on the substrate before the polarization separation film is arranged, an end surface of the second optical waveguide being opposed to a second surface which is a surface opposite to the first surface of the polarization separation film, and a waveguide direction of the second optical waveguide being a direction in which the second polarization signal propagates.

While the present invention has been described with reference to the exemplary embodiments, the present invention is not limited by the above description. Various changes that can be understood by one of ordinary skilled in the art can be made in the configurations and the details of the present invention within the scope of the present invention.

This application is based upon and claims the benefit of priority from Japanese Patent Application No. 2012-158615, filed on Jul. 17, 2012, the disclosure of which is incorporated herein in its entirety by reference.

### REFERENCE SIGNS LIST

1, 41, 43 POLARIZATION SEPARATION FILMS
2, 45, 46 ANALYZERS
10 LIGHT
10a, 31a LINEARLY POLARIZED LIGHT
11, 13 TE LIGHT
12 TM LIGHT
21, 32, 42, 44 LENSES
22 HALF-WAVE PLATE
31 LOCAL LIGHT
33 INTERFERENCE UNIT
34 PHASE DELAY MEANS
100 POLARIZATION SEPARATOR
101 SUBSTRATE
102 CLAD LAYER
103 GROOVE
104 GAP
105 LIGHT-INCIDENT END SURFACE
200-203 POLARIZATION SEPARATION STRUCTURES
300, 400 OPTICAL MIXERS
701, 703 OPTICAL WAVEGUIDES
702 POLARIZATION SEPARATION FILM
704 INCIDENT LIGHT
705 TM COMPONENT
706 TE COMPONENT
OC11-OC14, OC21-OC24 OPTICAL COUPLERS
WG1-3, WG11-WG18, WG21-WG28, WG31, WG32, WG41-WG44 OPTICAL WAVEGUIDES

1. A polarization separator comprising:
a substrate;
an analyzer that emits a linearly polarized light including a first polarization signal and a second polarization signal included in an incident light, the second polarization signal being different from the first polarization signal, and the intensity of the first polarization signal and the intensity of the second polarization signal being equal to each other;
a polarization separation film arranged on the substrate, the polarization separation film performing polarization separation on the linearly polarized light by transmitting the first polarization signal and reflecting the second polarization signal;
a first optical waveguide formed on the substrate, an end surface of the first optical waveguide being opposed to a first surface of the polarization separation film, and a waveguide direction of the first optical waveguide being a direction in which the first polarization signal propagates; and
a second optical waveguide formed on the substrate, an end surface of the second optical waveguide being opposed to a second surface which is a surface opposite to the first surface of the polarization separation film, and a waveguide direction of the second optical waveguide being a direction in which the second polarization signal propagates.

2. The polarization separator according to claim 1, wherein the linearly polarized light comprises a polarization plane which is between a polarization plane of the first polarization signal and a polarization plane of the second polarization signal.

3. The polarization separator according to claim 2, wherein:
the polarization plane of the first polarization signal is perpendicular to the polarization plane of the second polarization signal, and the polarization plane of the linearly polarized light is a plane obtained by rotating
the polarization plane of the first polarization signal and the polarization plane of the second polarization signal by 45°.

4. The polarization separator according to claim 1, wherein:
the linearly polarized light that is condensed is incident on the polarization separation film, and
the first optical waveguide and the second optical waveguide are arranged closer to a focal point of the condensed linearly polarized light than a distance in which a condensing plane of the linearly polarized light is within the end surface of the first optical waveguide and the end surface of the second optical waveguide.

5. The polarization separator according to claim 4, wherein polarization-multiplexed signal light is incident on the analyzer.

6. A polarization separation structure comprising:
the polarization separator according to claim 4; and
a condenser that condenses an incident light and focusing the incident light at a distance in which a condensing plane of the condensed light is within the end surface of the first optical waveguide and the end surface of the second optical waveguide,
wherein the analyzer emits the linearly polarized light to the condenser.

7. A polarization separation structure comprising:
the polarization separator according to claim 4; and
a condenser that condenses an incident light and focusing the incident light at a distance in which a condensing plane of the condensed light is within the end surface of the first optical waveguide and the end surface of the second optical waveguide,
wherein the analyzer is provided between the condenser and the polarization separation film.

8. The polarization separation structure according to claim 7, wherein polarization-multiplexed signal light is incident on the condenser.

9. An optical mixer comprising:
a first polarization separator that receives a condensed polarization-multiplexed signal light and performs polarization separation to separate the polarization-multiplexed signal light into a first polarization signal and a second polarization signal, the first polarization signal and the second polarization signal having polarization planes different from each other; and
an optical interference device that separates phases of the first polarization signal and the second polarization signal, wherein the first polarization separator comprises:
a substrate;
a first analyzer that emits a first linearly polarized light including the first polarization signal and the second polarization signal included in an incident light, the intensity of the first polarization signal and the intensity of the second polarization signal being equal to each other;
a first polarization separation film arranged on the substrate, the first polarization separation film performing polarization separation on the linearly polarized light by transmitting the first polarization signal and reflecting the second polarization signal;
a first optical waveguide formed on the substrate and connected to the optical interference device, an end surface of the first optical waveguide being opposed to a first surface of the first polarization separation film, and a waveguide direction of the first optical waveguide being a direction in which the first polarization signal propagates; and
a second optical waveguide formed on the substrate and connected to the optical interference device, an end surface of the second optical waveguide being opposed to a second surface which is a surface opposite to the first surface of the first polarization separation film, and a waveguide direction of the second optical waveguide being a direction in which the second polarization signal propagates.

10. A method for manufacturing a polarization separator comprising:
arranging an analyzer that emits a linearly polarized light including a first polarization signal and a second polarization signal included in an incident light, the second polarization signal being different from the first polarization signal, the intensity of the first polarization signal and the intensity of the second polarization signal being equal to each other, and the linearly polarized light being polarized and separated into the first polarization signal and the second polarization signal by a polarization separation film;
arranging the polarization separation film on a substrate so that the linearly polarized light is incident on the polarization separation film, the polarization separation film performing polarization separation on the linearly polarized light by transmitting the first polarization signal and reflecting the second polarization signal;
forming a first optical waveguide on the substrate before the polarization separation film is arranged, an end surface of the first optical waveguide being opposed to a first surface of the polarization separation film, and a waveguide direction of the first optical waveguide being a direction in which the first polarization signal propagates, and
forming a second optical waveguide on the substrate before the polarization separation film is arranged, an end surface of the second optical waveguide being opposed to a second surface which is a surface opposite to the first surface of the polarization separation film, and a waveguide direction of the second optical waveguide being a direction in which the second polarization signal propagates.

11. The optical mixer according to claim 9, wherein the first linearly polarized light comprises a polarization plane which is between a polarization plane of the first polarization signal and a polarization plane of the second polarization signal.

12. The optical mixer according to claim 11, wherein the polarization plane of the first polarization signal is perpendicular to the polarization plane of the second polarization signal, and the polarization plane of the first linearly polarized light is a plane obtained by rotating the polarization plane of the first polarization signal and the polarization plane of the second polarization signal by 45°.

13. The optical mixer according to claim 9, wherein the first linearly polarized light that is condensed is incident on the first polarization separation film, and the first optical waveguide and the second optical waveguide are arranged closer to a focal point of the condensed first linearly polarized light than a distance in which a condensing plane of the first linearly polarized light is within the end surface of the first optical waveguide and the end surface of the second optical waveguide.

14. The optical mixer according to claim 13, wherein the polarization-multiplexed signal light is incident on the first analyzer.

15. The optical mixer according to claim 13, further comprising a first condenser that condenses an incident light and focusing the incident light at a distance in which a condensing plane of the condensed light is within the end surface of the first optical waveguide and the end surface of the second optical waveguide, wherein the first analyzer emits the first linearly polarized light to the first condenser.

16. The optical mixer according to claim 13, further comprising a first condenser that condenses an incident light and focusing the incident light at a distance in which a condensing plane of the condensed light is within the end surface of the first optical waveguide and the end surface of the second optical waveguide, wherein the first analyzer is arranged between the first condenser and the polarization separation film.

17. The optical mixer according to claim 16, wherein the polarization-multiplexed signal light is incident on the first condenser.

18. The optical mixer according to claim 11, wherein the optical interference device interferes each of the first and second polarization signals separated by the polarization separation performed by the first polarization separation film with a local light, and outputs two signal light beams having phases different from each other by π/2 from each of the first and second polarization signals.

19. The optical mixer according to claim 18, wherein the local light is separated into a first local light and a second local light, and the optical mixer interferes the first polarization signal with the first local light and interferes the second polarization signal with the second local light.

20. The optical mixer according to claim 19, wherein the first local light has a polarization plane same as that of the first polarization signal and the second local light has a polarization plane same as that of the second polarization signal.
